(19) United States
(12) Patent Application Publication
(10) Pub. No.: US 2026/0346991 A1
(43) Pub. Date: Nov. 5, 2026

(54) AIR INLET OF AN AIRCRAFT TURBOMACHINE NACELLE, AND ASSOCIATED METHOD

(71) Applicant: SAFRAN NACELLES, GONFREVILLE-L'ORCHER (FR)

(72) Inventors: Laurent BLIN, MOISSY-CRAMAYEL (FR); Denis GUILLOIS, MOISSY-CRAMAYEL (FR); Fabienne QUENU, MOISSY-CRAMAYEL (FR); Patrick GONIDEC, MOISSY-CRAMAYEL (FR)

(21) Appl. No.: 19/486,125

(22) PCT Filed: May 25, 2024
(86) PCT No.: PCT/EP2024/064462

§ 371 Date: Nov. 20, 2025

(30) Foreign Application Priority Data
May 30, 2023 (FR) FR2305327

(51) Int. Cl. B64D 15/16; B64D 33/02; F02C 7/045

(52) U.S. Cl. CPC B64D 15/16; B64D 33/02; B64D 2033/0206; B64D 2033/0233; F02C 7/045; F05D 2220/323; F05D 2260/96

(57) ABSTRACT

An air inlet of an aircraft turbomachine nacelle extending along a main axis (X) oriented from front to rear. The air inlet includes at least one acoustic device including an acoustic core on the inner wall between the inner wall and the outer wall, the inner wall comprising including at least one perforated portion facing the acoustic core so as to allow the passage of acoustic waves, and at least one vibratory de-icing member positioned in the inner cavity between the acoustic core and the perforated portion, the vibratory de-icing member being in contact with the perforated portion of the inner wall in order to make it vibrate, and at a distance from the acoustic core.

### TECHNICAL FIELD

The present invention relates to the field of aircraft turbomachines and is aimed more specifically at an air inlet for an aircraft nacelle comprising a de-icing device and an acoustic device.

The climate change is a major concern for many legislative and regulatory members around the world. In fact, various restrictions on carbon emissions have been, are being or will be adopted by different countries. In particular, an ambitious standard applies both to new airplane types and to those already in circulation, requiring the implementation of technological solutions to bring them into line with current regulations. The civil aviation industry has been mobilizing for several years now to make a contribution to the fight against climate change.

The technological research efforts have already led to significant improvements in the environmental performance of airplanes. The Applicant takes into account the impacting factors in all phases of design and development to obtain aeronautical components and products that consume less energy, are more respectful of the environment and whose integration and use in civil aviation have moderate environmental consequences with the aim of improving the energy efficiency of airplanes.

Consequently, the Applicant is constantly working to reduce its negative impact on the climate through the use of virtuous development and the manufacturing methods and processes that minimize the greenhouse gas emissions to the minimum possible in order to reduce the environmental footprint of its activity.

This ongoing research and development work focuses on the new generations of aircraft engines, making the apparatus lighter, particularly through the use of lighter materials and onboard equipment, developing the use of electric technologies for propulsion, and, as an essential complement to technological progress, the aeronautical biofuels.

In a known way, an aircraft has one or more turbomachines to enable it to be propelled by the acceleration of a flow of air which circulates back and forth in the turbomachine.

With reference to FIG. 1, a turbomachine 1 is shown extending along a main axis X oriented from front to rear and comprising a fan 11 mounted so as to rotate about the main axis X in a nacelle comprising an outer shell 12. Hereinafter, the terms “front” and “rear” are defined in relation to the flow of air F. The turbomachine 1 comprises an air inlet 2 at its front end, comprising an inner cavity 20, extending annularly around the main axis X, which comprises an inner wall 21 facing the main axis X and an outer wall 22 opposite the inner wall 21. The walls 21, 22 are connected by a leading edge 23, also known as the “air inlet lip”. The inner cavity 20 is bounded at the rear by a bulkhead 24. Thus, the air inlet 2 allows to separate the incoming air flow F into an inner air flow FINT guided by the inner wall 21 and an outer air flow FEXT guided by the outer wall 22. Hereafter, the terms inner and outer are defined radially with respect to the main axis X.

As is well known, when an aircraft is in flight, temperature and pressure conditions may cause ice to accumulate near the leading edge 23 and the inner wall 21 of the air inlet 2, forming blocks of ice that may be ingested by the turbomachine 1. Such ingestions must be avoided in order to improve the service life of turbomachine 1 and reduce malfunctions.

To eliminate ice build-up, with reference to FIG. 2, it is known to circulate a hot air flow FAC in the inner cavity 20 in order to heat the inner wall 21 by thermal convection and thus avoid the build-up of ice, which melts as it accumulates.

The hot air flow FAC is introduced into the inner cavity 20 by an injector 300, traditionally in the form of a tube with a cylindrical cross-section oriented in a direction perpendicular to the main axis X, as shown in FIG. 2. The hot air flow FAC moves circumferentially in the inner cavity 20 to heat the inner wall 21.

Furthermore, in order to reduce acoustic emissions, with reference to FIG. 3, it is known to provide an acoustic device 103 in the inner cavity 20 of the air inlet 2 which comprises, on the one hand, a honeycomb acoustic core 130, which is positioned on the inner wall 21 of the lip 2 and, on the other hand, a resistive outer skin 132 mounted externally to the honeycomb acoustic core 130. To this end, the inner wall 21 comprises a perforated portion 21a to capture acoustic waves and attenuate them. Such a front acoustic device 103 is compatible with a de-icing of the air inlet 2 by circulation of a hot air flow FAC. Similarly, an acoustic panel 103′ is known to be positioned behind the air inlet 2, in particular behind the bulkhead 24.

In practice, the energy efficiency of this type of heating system is low and requires a significant amount of hot air flow FAC to be extracted from the turbomachine. In addition, it is necessary to provide materials compatible with hot air flow FAC, which increases cost and complexity.

In order to eliminate this drawback, with reference to FIG. 4, it is known to use a vibration de-icing device 104 comprising a plurality of piezoelectric elements 140 in the inner cavity 20 of the air inlet 2 on the inner wall 21 of the lip 2 in order to make it vibrate and prevent the formation of ice. Such piezoelectric elements 140 only need to be electrically powered, which presents fewer constraints compared to de-icing the air inlet 2 by circulating a hot air flow FAC. However, the installation of piezoelectric elements 140 on the inner wall 21 of the air inlet 2 prevents the mounting of an acoustic device 103 in the inner cavity 20. In fact, the piezoelectric elements 140 must be positioned in place of the honeycomb acoustic core 130 as shown in FIG. 3.

To achieve high acoustic performance with piezoelectric elements 140, one solution is to lengthen the air inlet 2 so that a long acoustic panel 103′ may be positioned. This has the disadvantage of increasing the mass and drag of the air inlet 2.

The document US20100301161A1 presents an acoustic coating comprising a heating layer. When the risk of ice is limited, it is advisable to install vibratory members on the outer wall of the air inlet.

The aim of the invention is to eliminate this disadvantage by proposing a turbomachine nacelle air inlet which comprises an acoustic device in the inner cavity of the lip and which is de-iced by vibration.

### SUMMARY OF THE INVENTION

To this end, the invention is the result of technological research aimed at significantly improving aircraft performance and, in this sense, contributes to reducing the environmental impact of aircrafts, the invention relates to an air inlet of an aircraft turbomachine nacelle extending around a main axis oriented from front to rear, the air inlet comprising an inner cavity extending annularly around the main axis and comprising an inner wall facing the main axis and an outer wall opposite the inner wall, the walls being connected by a leading edge, the air inlet comprising at least one acoustic device mounted on the inner wall between the inner wall and the outer wall, the acoustic device comprising an acoustic core, the inner wall comprising at least one perforated portion facing the acoustic core so as to allow the passage of acoustic waves.

The air inlet is remarkable in that it comprises at least one vibratory de-icing member positioned between the acoustic core and the perforated portion, the vibratory de-icing member being in contact with the perforated portion of the inner wall in order to make it vibrate, and at a distance from the acoustic core.

Advantageously, it is not necessary to consume a flow of hot air to carry out de-icing, which allows to use materials that are less expensive and complex to work with. Thanks to the integrated vibratory de-icing member, an efficient de-icing may be achieved without compromising the acoustic performance. It is not necessary to lengthen the air inlet to install an acoustic panel offset with respect to the vibratory de-icing member. As a consequence, there is no compromise on fuel consumption or space. Mounting the vibratory de-icing member at a distance from the acoustic core allows to prevent the vibrations from being transmitted to the latter. The service life of the acoustic device is therefore not “affected”. The use of a vibratory de-icing member consumes less energy than de-icing with a hot air flow, which is beneficial from an environmental point of view.

In one aspect, the acoustic core is alveolar, preferably, honeycombed.

According to one aspect, the vibratory de-icing member is of the piezoelectric type. This allows de-icing to be carried out without using hot air. Only a power supply is required to generate a vibration. Its overall dimensions are also reduced.

According to one aspect, an interspace is defined between the acoustic core and the perforated portion, and a porous material is positioned in the interspace. This allows the vibratory de-icing member and the acoustic core to be physically isolated to facilitate the mounting. Advantageously, the vibrations are not transmitted from the performed portion to the acoustic core.

According to one aspect, the interspace having a volume, the porous material occupies at least 50% of the volume of the interspace, preferably at least 80%. This allows for optimal acoustic performance while providing mechanical support.

According to one aspect, as the vibratory de-icing member has a thickness defined in a direction normal to the inner wall, the acoustic core of the acoustic device is spaced from the inner wall by a spacing distance defined in a direction normal to the inner wall, which is greater than the thickness of the vibratory de-icing member. This allows the use of an acoustic core of constant thickness to achieve a uniform acoustic attenuation. The assembly is also simplified.

According to one aspect, the acoustic core having a thickness defined in a direction normal to the inner wall, the vibratory de-icing member extends into the thickness of the acoustic core. This allows for reduced bulk by integrating the vibratory de-icing member into the thickness of the acoustic core.

According to one aspect, the vibratory de-icing device comprises at least one power cable configured to be connected to a control device in order to supply it electrically, the power cable being positioned in the interspace. The presence of an interspace also enables easy routing of power cables with low constraints.

According to one aspect, the air inlet comprises a plurality of vibratory de-icing members positioned between the acoustic device and the perforated portion, the plurality of vibratory de-icing members being in contact with the perforated portion of the inner wall in order to make it vibrate.

According to one aspect, the inner cavity is bounded at the rear by a bulkhead.

According to one aspect, the acoustic device being mounted in the inner cavity, the vibratory de-icing member is positioned in the inner cavity. This allows the air inlet lip to be de-iced in a beneficial manner.

According to one aspect, the inner cavity is bounded at the rear by a bulkhead, the acoustic device being mounted downstream of the bulkhead, and the vibratory de-icing member is positioned downstream of the bulkhead. This allows a zone further downstream from the air inlet to be de-iced.

The invention also relates to an aircraft turbomachine nacelle extending along a main axis oriented from front to rear, the nacelle comprising an air inlet as previously presented.

The invention also relates to an aircraft comprising a turbomachine nacelle as described above.

The invention also relates to a method of using an air inlet as presented above, the method comprising at least one step consisting of:
Electrically energizing the vibratory de-icing member so as to vibrate the perforated portion of the inner wall in order to de-ice it, and
Attenuating the sound waves passing through the perforated portion of the inner wall with the acoustic device.

### BRIEF DESCRIPTION OF FIGURES

The invention will be better understood on reading the following description, which is given by way of example, with reference to the following figures, given as non-limiting examples, in which identical references are given to similar objects.

FIG. 1 is a schematic representation of an air inlet of a nacelle according to the prior art.

FIG. 2 is a schematic cross-sectional representation of the circulation of a hot air flow in the air inlet according to the prior art.

FIG. 3 is a schematic cross-sectional view of an air inlet comprising a hot-air de-icing device according to the prior art, an acoustic device and an acoustic panel.

FIG. 4 is a schematic cross-sectional view of an air inlet with a vibration de-icing device according to the prior art.

FIG. 5 is a schematic cross-sectional representation of an air inlet according to one embodiment of the invention.

FIG. 6 is a close-up schematic representation of FIG. 5.

FIG. 7 is a close-up schematic representation of FIG. 6.

FIG. 8 is a close-up schematic representation of another air inlet design.

FIG. 9 is a close-up schematic representation of another air inlet design.

FIG. 10 is a close-up schematic representation of FIG. 9.

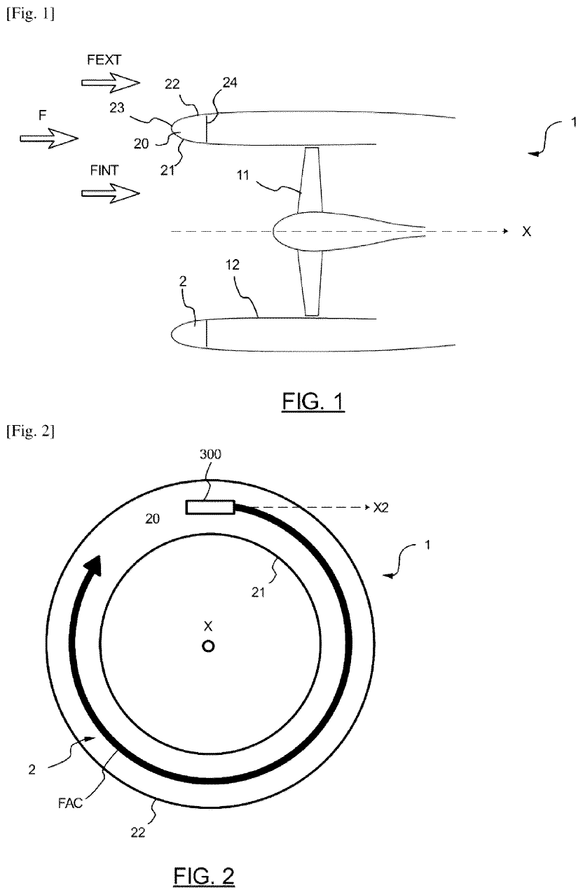

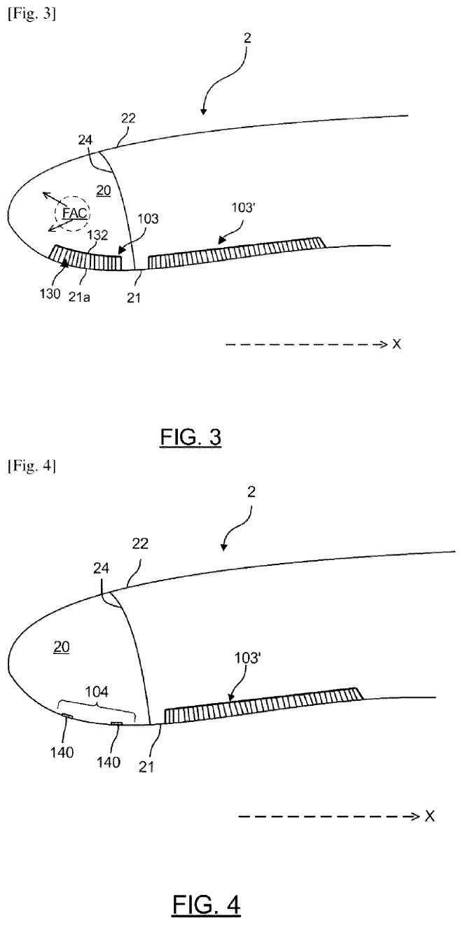

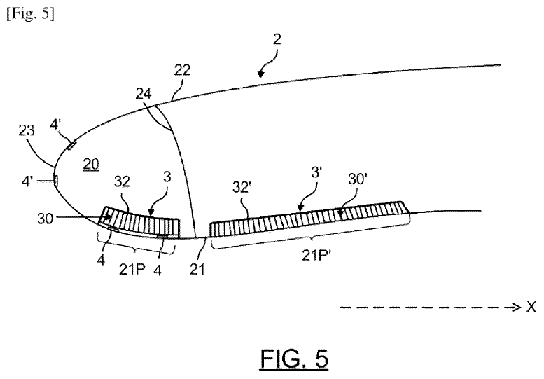

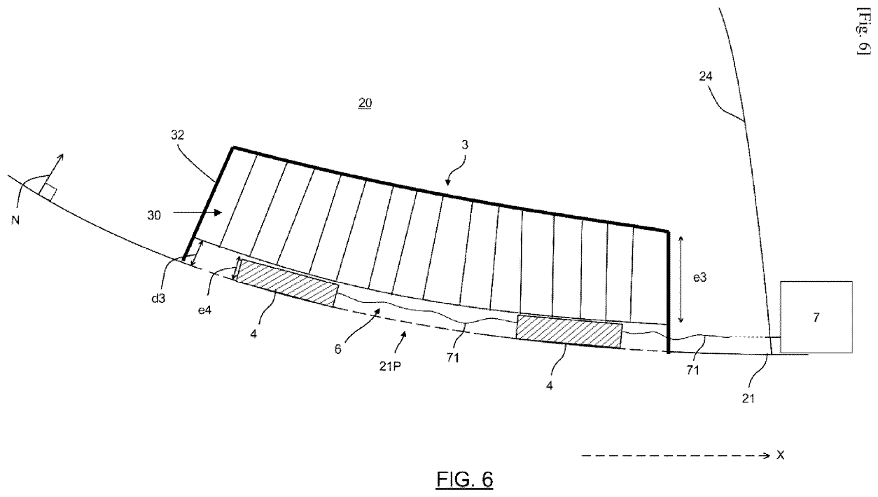

It should be noted that the figures set out the invention in detail in order to implement the invention, said figures of course being able to be used to better define the invention where appropriate.

### DETAILED DESCRIPTION OF THE INVENTION

The invention relates to the field of aircraft turbomachine, and more specifically to an air inlet of an aircraft turbomachine nacelle.

With reference to FIG. 1, a turbomachine 1 is shown extending along a main axis X oriented from front to rear and comprising a fan 11 mounted to rotate about the main axis X in a nacelle comprising an outer casing 12. Hereinafter, the terms “front” and “rear” are defined in relation to the flow of air F. The turbomachine 1 comprises an air inlet 2 at its front end, comprising an inner cavity 20, extending annularly around the main axis X, which comprises an inner wall 21 facing the main axis X and an outer wall 22 opposite the inner wall 21. The walls 21, 22 are connected by a leading edge 23, also known as the “air inlet lip”. The inner cavity 20 is bounded at the rear by a bulkhead 24. Thus, the air inlet 2 allows to separate the incoming air flow F into an inner air flow FINT guided by the inner wall 21 and an outer air flow FEXT guided by the outer wall 22. Hereafter, the terms inner and outer are defined radially with respect to the main axis X. The general structure of an air inlet 2 is known to the person skilled in the art and will not be presented again in detail.

FIG. 5 is a cross-sectional view of an air inlet 2 according to one embodiment of the invention. In this example, the air inlet 2 comprises an acoustic device 3 mounted in the inner cavity 20. The air inlet 2 also comprises a further acoustic panel 3′ mounted externally to the inner cavity 20. Thus, the acoustic device 3 is mounted upstream of the bulkhead 24, while the acoustic panel 3′ is mounted behind the bulkhead 24. The acoustic panel 3′ is optional but useful for reducing noise pollution.

As illustrated in FIG. 5, the inner wall 21 comprises a perforated portion 21P and a rear perforated portion 21 P′ respectively facing the acoustic device 3 and the acoustic panel 3′ so as to allow the passage of acoustic waves in order to attenuate them.

Preferably, the acoustic device 3 comprises an acoustic core 30 and an outer skin 32 covering the acoustic core 30. Similarly, the acoustic panel 3′ comprises an acoustic core 30′ and an outer skin 32′ covering the acoustic core 30′. Each acoustic core 30, 30′ preferably has a honeycomb structure, for example. The acoustic core 30, 30′ is made of a composite or metallic material. The outer skin 32, 32′ is made of a composite or metallic material and is integral with the inner wall 21.

The invention is remarkable in that the air inlet 2 comprises several vibratory de-icing members 4 positioned in the inner cavity 20 between the acoustic device 3 and the perforated portion 21P. As illustrated in FIG. 5, the vibratory de-icing members 4 are in contact with the perforated portion 21P of the inner wall 21 in order to make it vibrate. The introduction of vibratory de-icing members 4 on the perforated portion 21P allows for de-icing that consumes less energy than de-icing with a hot air flow as in the prior art. The vibration of the vibratory de-icing members 4 causes the perforated portion 21P to move by a few micrometers, which breaks up any ice that is already present.

In practice, the presence of vibratory de-icing members 4 has only a minor effect on the transmission of acoustic waves in the acoustic device 3, which allows good acoustic attenuation performance to be maintained. When a plurality of vibratory de-icing members 4 are uniformly distributed over the perforated portion 21P of the inner wall 21, it is advantageous to achieve uniform de-icing while maximizing acoustic attenuation.

Preferably, the vibratory de-icing members 4 are spaced apart, both axially and circumferentially to the main axis X, by a distance ranging from 10 mm to 300 mm. This allows in particular for easier routing of their power cables, as will be shown below.

Each vibratory de-icing member 4 is at a distance from the acoustic core 30 of the acoustic device 3 in order to prevent it from vibrating. In fact, the vibration of the acoustic core 30 of the acoustic device 3 would cause rapid wear and reduce its service life.

In this example, the use of several vibratory de-icing members 4 positioned in the inner cavity 20 has been presented, but it goes without saying that the invention also applies to a single vibratory de-icing member 4 positioned in the inner cavity 20.

Similarly, without departing from the scope of the invention, the vibratory de-icing members 4 could be positioned downstream of the bulkhead 24 between the acoustic panel 3′ and the perforated portion 21P′ as illustrated in FIG. 5. The important thing is to maintain a gap between the perforated portion 21P, 21P′, on which the vibratory de-icing members 4 are positioned, and the acoustic device 3/acoustic panel 3′. The positioning of the vibratory de-icing members 4 upstream or downstream of the bulkhead 24 is irrelevant.

In this example, as illustrated in FIG. 5, the air inlet 2 also comprises auxiliary vibratory de-icing members 4′ positioned on the air inlet lip 23 and on the outer wall 22. This advantageously allows the various parts of the air inlet 2 to be de-iced evenly.

Preferably, each vibratory de-icing member 4, 4′ is of the piezoelectric type and is configured to vibrate when it receives an electrical supply current. This allows the wall on which it is mounted to vibrate in order to de-ice it.

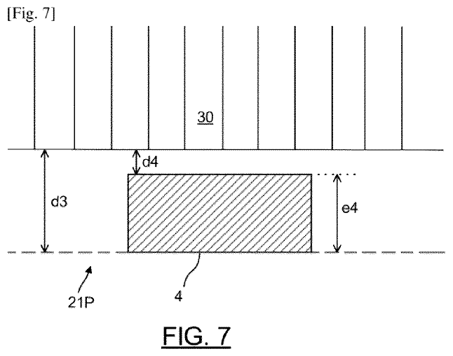

As will be shown later, the vibratory de-icing members 4 positioned in contact with the perforated portion 21P and the auxiliary vibratory de-icing members 4′ are connected to a control device 7 (FIGS. 6, 8 and 9) via control wires 71 so that they may be supplied with electrical power.

According to a first embodiment shown in FIG. 6, the acoustic core 30 is spaced apart from the inner wall 21, in particular from the perforated portion 21P, by a spacing distance d3. The spacing distance d3 is defined relative to a direction N normal to the inner wall 21. In particular, the spacing distance d3 is measured between the inner end of the acoustic core 30 and the inner wall 21.

Thus, the air inlet 2 comprises an interspace 6 defined in the inner cavity 20 between the acoustic device 3 and the perforated portion 21P as shown in FIG. 6. Preferably, the spacing distance d3 is between 0.1 mm and 1.5 mm.

The presence of an interspace 6 allows space to be reserved for positioning the vibratory de-icing members 4. The acoustic waves thus travel through the interspace 6 before being attenuated by the acoustic core 30 of the acoustic device 3.

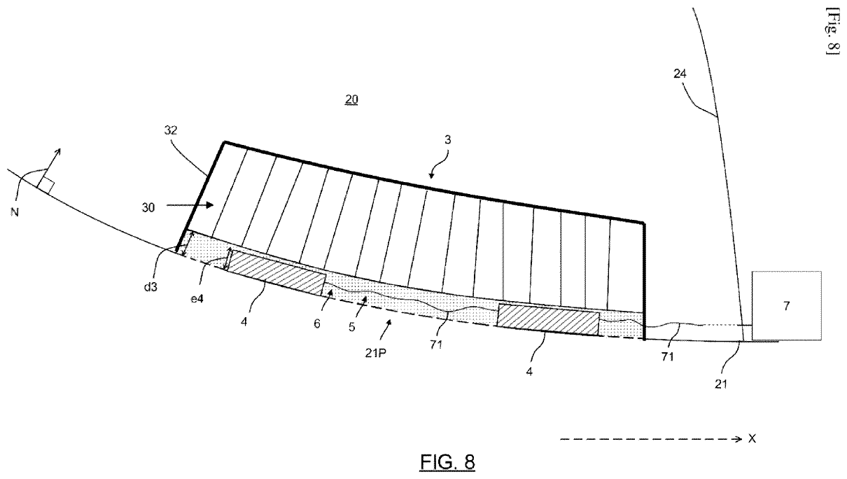

In this example, with reference to FIGS. 6 and 7, each vibratory de-icing member 4 has a thickness e4 defined along a direction normal N to the inner wall 21.

With reference to FIGS. 6 and 7, the spacing distance d3 is greater than the thickness e4 of each vibratory de-icing member 4. This allows the vibratory de-icing members 4 to be mounted with minimal stress, which is advantageous. The acoustic core 30 advantageously has a constant thickness e3 and homogeneous acoustic performances. As illustrated in FIG. 7, each vibratory de-icing member 4 is spaced from the acoustic core 30 in the direction normal N to the inner wall 21 by a normal protection distance d4 which is greater than or equal to 0.1 mm. Such a normal protective distance d4 advantageously allows for functional movement of each vibratory de-icing member 4 when activated. This allows no contact with the acoustic core 30.

Preferably, the thickness e4 of each vibratory de-icing member 4 is between 1 mm and 5 mm. According to a preferred aspect, if the spacing distance d3 is less than 1.5 mm, the thickness e4 of each vibratory de-icing member 4 is between 0.5 mm and 1.4 mm. Preferably, each vibratory de-icing member 4 has a length, defined parallel to the inner wall 21, of between 6 mm and 70 mm.

In this example, with reference to FIG. 6, each vibratory de-icing device 4 comprises a power cable 71 connected to a control device 7 in order to supply it with electricity. Advantageously, the power cable 71 is positioned in the inner cavity 20 between the acoustic device 3 and the perforated portion 21P. The interspace 6 is advantageously used to install the vibratory de-icing devices 4 and the associated power cables 71. This makes mounting quick and easy. Preferably, the control device 7 is positioned behind the bulkhead 24.

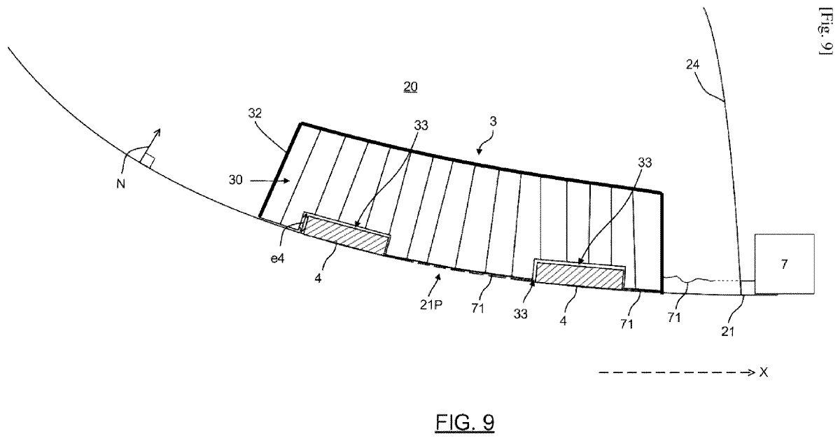

A second embodiment is shown in FIG. 8. For the sake of clarity and conciseness, elements common to the first form of implementation will not be presented again.

In this second embodiment, a porous material 5 is positioned in the inner cavity 20 between the acoustic device 3 and the perforated portion 21P. The porous material 5 is porous in the acoustic sense. With reference to FIG. 8, the porous material 5 is positioned in the interspace 6 between the acoustic core 30 and the perforated portion 21P. As the interspace 6 has a volume, the porous material 5 occupies at least 50% of the volume of the interspace 6, preferably at least 80%.

Preferably, the porous material 5 has a flexibility that advantageously allows sealing and aerodynamic smoothing of the inner wall 21. Such flexibility or pliability advantageously facilitates the filling of the interspace 6.

Preferably, the porous material 5 is connected to the inner wall 21, which advantageously allows for better support of the acoustic device 3 by reducing the forces induced by displacement of the porous material 5 in the interspace 6.

The porous material 5 is preferably in the form of felt or foam, which insulates the acoustic core 30 from the vibrations emitted by the vibratory de-icing members 4, while allowing the acoustic waves to pass through. The porous material 5 advantageously performs a mechanical damping function. The interspace 6 is thus filled, which allows greater stability during assembly and improves service life.

A third embodiment is shown in FIG. 9. For the sake of clarity and conciseness, elements common to the first form of implementation will not be presented again.

In this third embodiment, the spacing distance d3 is less than the thickness e4 of each vibratory de-icing member 4. Thus, the vibratory de-icing members 4 extend partially into the thickness of the acoustic core 30. The normal protective distance d4 is not zero, so as to prevent the transmission of mechanical vibrations from the inner wall 21 to the acoustic core 30. Similarly, each vibratory de-icing member 4 is spaced from the acoustic core 30, into which it extends by a non-zero axial protection distance d6. Similarly, each vibratory de-icing member 4 is spaced from the acoustic core 30, into which it extends by a non-zero circumferential protection distance. Preferably, the normal protection distance d4, the axial protection distance d6 and the circumferential protection distance are greater than 0.1 mm. By the same token, such protective distances advantageously allow each vibratory de-icing member 4 to move freely when activated. This allows no contact with the acoustic core 30.

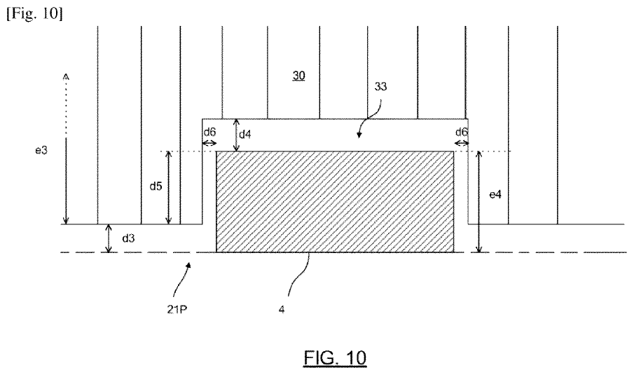

With reference to FIG. 10, an insertion distance d5 is defined in a direction normal N to the inner wall 21, corresponding to the portion of each de-icing member 4 that extends into the thickness e3 of the acoustic core 30 of the acoustic device 3. This advantageously allows to reduce the overall dimensions in the inner cavity 20 of the air inlet 2.

Referring to FIG. 9, the acoustic device 3 comprises a plurality of housings 33 in which the vibratory de-icing members 4 are positioned. At least one housing 33, preferably each, is in the form of a cutout in the acoustic core 30.

Similarly to the second embodiment, a porous material 5 may be positioned in the interspace 6 defined for the third embodiment, even if the latter is reduced.

One or more acoustic devices 3 positioned in the inner cavity 20 and one or more vibratory de-icing members 4 positioned in the inner cavity 20, i.e. upstream of the bulkhead 24, have been presented. The invention applies more generally to one or more acoustic devices 3 positioned on the inner wall 21 between the inner wall 21 and the outer wall 22, as well as one or more vibratory de-icing members 4 positioned on the inner wall 21 between the inner wall 21 and the outer wall 22. In particular, the invention applies to one or more acoustic devices 3 positioned downstream of the bulkhead 24, as well as one or more vibratory de-icing members 4 positioned downstream of the bulkhead 24. In particular, the invention applies to one or more acoustic devices 3 positioned upstream and downstream of the bulkhead 24, as well as one or more vibratory de-icing members 4 positioned upstream and downstream of the bulkhead 24.

An example of a method for using an air inlet 2 according to the invention will now be presented with reference to the embodiment shown in FIG. 8, The method includes a step consisting in electrically powering the vibratory de-icing members 4 so as to vibrate the perforated portion 21P of the inner wall 21 in order to de-ice it. The control device 7 supplies power to the vibratory de-icing members 4 via the power cables 71 to make them vibrate. Advantageously, the vibrations are not transmitted to the acoustic core 30. The use of a porous material 5 facilitates assembly by forming a mechanical damper.

Advantageously, the auxiliary vibratory de-icing member 4′ (FIG. 5) are also set to vibration so as to de-ice all the walls of the air inlet 2.

The method includes a step of attenuating the acoustic waves passing through the perforated portion 21P of the front inner wall 21 with the acoustic device 3. The acoustic waves propagate in the intermediate space 6 to be attenuated in the cells of the acoustic device 3, which advantageously form Helmholtz-type resonators.

Advantageously, the acoustic panel 3′ (FIG. 5) also allows its acoustic attenuation function. Because the vibratory de-icing members 4 are integrated with the acoustic device 3, the acoustic performance is advantageously not degraded. This eliminates the need to lengthen the air inlet 2 to accommodate an acoustic panel 3′ of increased length.

1. An air inlet of an aircraft turbomachine nacelle extending around a main axis oriented from front to rear, the air inlet comprising:
an inner cavity extending annularly around the main axis and comprising an inner wall facing the main axis and an outer wall opposite the inner wall, the walls inner wall and the outer wall being connected by a leading edge,
at least one acoustic device mounted on the inner wall between the inner wall and the outer wall, the acoustic device comprising an acoustic core, wherein the inner wall includes at least one perforated portion facing the acoustic core so as to allow a passage of acoustic waves, and
at least one vibratory de-icing member positioned between the acoustic core and the perforated portion, the vibratory de-icing member being in contact with the perforated portion of the inner wall in order to make it vibrate, and at a distance from the acoustic core.

2. The air inlet according to claim 1, wherein an interspace is defined between the acoustic core and the perforated portion

3. The air inlet according to claim 2, wherein a porous material is positioned in the interspace.

4. The air inlet according to claim 1, wherein the vibratory de-icing member defines a thickness in a direction normal to the inner wall, the acoustic core of the acoustic device

5. is spaced from the inner wall by a spacing distance, defined in the normal direction which is greater than the thickness of the vibratory de-icing member.

5. The air inlet according to claim 1, wherein the acoustic core defines a thickness along a direction normal to the inner wall, the vibratory de-icing member extends into the thickness of the acoustic core.

6. The air inlet according to claim 2, wherein the vibratory de-icing device comprises at least one power cable configured to be connected to a control device to supply it electrically, the power cable being positioned in the interspace.

7. The air inlet according to claim 1, wherein the at least one vibratory de-icing member includes a plurality of vibratory de-icing members positioned between the acoustic device and the perforated portion, the plurality of vibratory de-icing members-being in contact with the perforated portion of the inner wall in order to make it vibrate.

8. The air inlet according to claim 1, wherein the acoustic device being mounted in the inner cavity, the vibratory de-icing member is positioned in the inner cavity.

9. The aircraft turbomachine nacelle extending along the main axis oriented from the front to the rear, the nacelle comprising the air inlet according to claim 1.

10. A method of using the air inlet according to claim 1, the method comprising:
electrically energizing the vibratory de-icing member so as to vibrate the perforated portion of the inner wall in order to de-ice it, and
attenuating the acoustic waves passing through the perforated portion of the inner wall with the acoustic device.
